(19) United States
(12) Patent Application Publication
(10) Pub. No.: US 2008/0235284 A1
(43) Pub. Date: Sep. 25, 2008

(54) Method and Apparatus For Analysing An Emotional State of a User Being Provided With Content Information

(75) Inventors: Ronaldus Maria Aarts, Eindhoven (NL); Ralph Kurt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/067,951

(22) PCT Filed: Sep. 22, 2006
(86) PCT No.: PCT/IB2006/053442

§ 371 Date: Mar. 25, 2008

(30) Foreign Application Priority Data
Sep. 26, 2005 (EP) 05108838.3

(51) Int. Cl. G06F 17/30

(52) U.S. Cl. 707/104.1; 707/E17.001

(57) ABSTRACT

The invention relates to a method of analysing an emotional state of a user being provided with content information in a consumer electronics interface. The method comprises steps of: (210) obtaining physiological data indicating the user's emotional state; (230) identifying a part of the content information related to the physiological data; and (240) storing the physiological data with a reference to the related part of the content information. The invention also relates to a device, a data storage for storing physiological data, and to a computer program.

The invention relates to a method of analysing an emotional state of a user being provided with content information in a consumer electronics interface. The invention also relates to a device for analysing an emotional state of a user being provided with content information in a consumer electronics interface, to a data storage for storing physiological data, and to a computer program.

U.S. Pat. No. 6,798,461 discloses a video system comprising a display for displaying video data to a viewer, a sensor attached to a finger of the viewer for sensing physiological data such as a pulse rate or a skin conductance, and a video-mixing device for receiving the video data. The video-mixing device is arranged to receive the physiological data and display them while the viewer watches the video data. The system permits the viewer to monitor the physiological data while enjoying video content.

The known system allows to display the physiological data measured in real time and the video content simultaneously. With that system, the viewer may not communicate an experience of viewing the video content with another person who does not view the same video content.

It is desirable to provide a method of analysing an emotional state of a user being provided with content information, which allows the user to communicate the user's experience.

The method comprising steps of:
obtaining physiological data indicating the user's emotional state;
identifying a part of the content information related to the physiological data; and
storing the physiological data with a reference to the related part of the content information.

When the content information is provided to the user, measurable physiological processes may indicate that the user experiences certain emotions related to the content information. For example, the skin resistance changes when the user suddenly experiences fright induced by a movie currently watched by the user. To register the user's emotional state, a signal with the physiological data, e.g. a galvanic skin response measurement, Electromyogram measurement or a pupil size, is obtained.

As the user progressively consumes the content information, the emotional state of the user may change. Accordingly, the physiological data may vary as well. Therefore, a part of the content information is identified that corresponds to particular physiological data obtained at a specific moment of time. The physiological data with references to the corresponding parts of the content information allow to tangibly express the experience of the user.

Once the user has been provided with the content information, it may be desirable to preserve the experience of the user for later use. Therefore, the physiological data are stored with a reference to the related part of the content information. By storing the physiological data, a time shift is created to allow a usage of the physiological later on. The stored physiological data may be used to reproduce the content information again and to show the emotional state experienced by the user. The stored physiological data with the references to the related parts of the content information may also be communicated to another user or compared with physiological data of the other user.

In the present invention, a device is provided for analysing an emotional state of a user being provided with content information in a consumer electronics interface. The device comprises a data processor for
obtaining physiological data indicating the user's emotional state;
identifying a part of the content information related to the physiological data; and
enabling to store the physiological data with a reference to the related part of the content information.

The device is configured to operate as described with reference to the method.

These and other aspects of the invention will be further explained and described, by way of example, with reference to the following drawings:

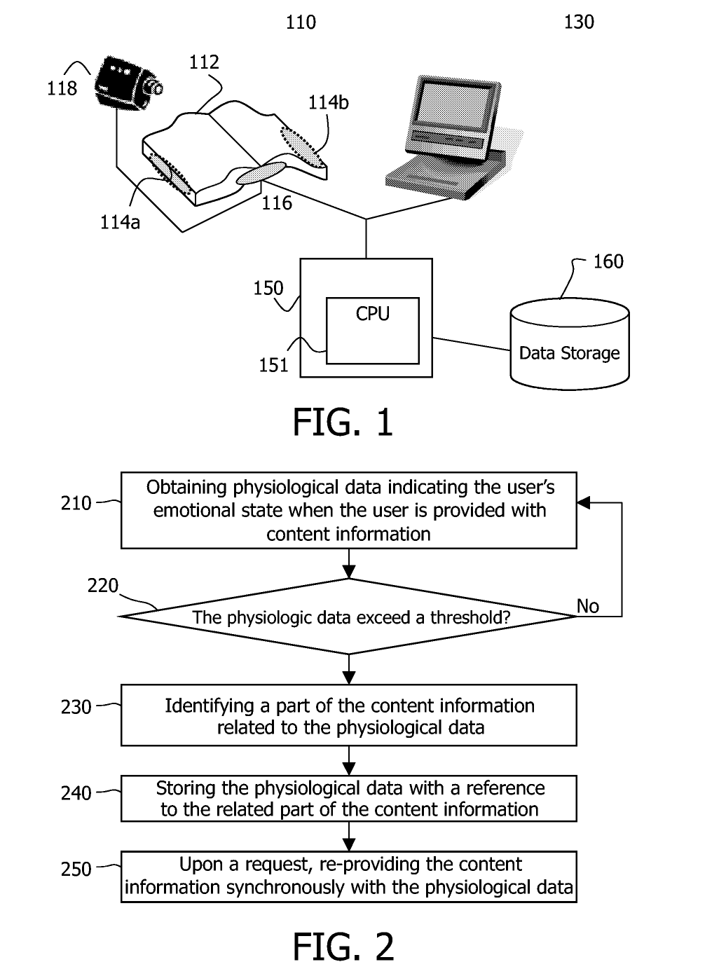

FIG. 1 is a functional block diagram of an embodiment of a system according to the present invention;

FIG. 2 is an embodiment of the method of the present invention.

In consumer electronics systems, a user may be provided with content information (or simply “content”) in various ways. For example, the user may read a book with a removable cover incorporating some electronics for detecting a page currently read in the book by the user. In another example, the user may watch a soccer game on a TV screen or a PC display. When the user is provided with the content, it may mean that the user consumes the content without assistance of any display or audio reproduction devices, e.g. by reading the book, or that the user consumes the content by watching or listening to a consumer electronics device.

The content may comprise at least one of, or any combination of, visual information (e.g., video images, photos, graphics), audio information, and text information. The expression “audio information” means data pertaining to audio comprising audible tones, silence, speech, music, tranquility, external noise or the like. The audio data may be in formats like the MPEG-1 layer III (mp3) standard (Moving Picture Experts Group), AVI (Audio Video Interleave) format, WMA (Windows Media Audio) format, etc. The expression “video information” means data, which are visible such as a motion, picture, “still pictures”, videotext etc. The video data may be in formats like GIF (Graphic Interchange Format), JPEG (named after the Joint Photographic Experts Group), MPEG-4, etc. The text information may be in the ASCII (American Standard Code for Information Interchange) format, PDF (Adobe Acrobat Format) format, HTML (HyperText Markup Language) format, for example.

FIG. 1 shows an embodiment of a system comprising two user interfaces 110 and 130 and a device 150. In the user interface 110, the user may read a book 112 placed in a (optionally, removable) book cover incorporating electrodes 114a and 114b. The electrodes 114a and 114b may be connected to a monitoring processor 116. When the user reads the book, a galvanic skin response is measured via the electrodes 114a and 114b for generating a suitable signal with the measurement. Further, the signal is supplied (wirelessly) to the monitoring processor 116. In another example, the electrodes 114a and 114b are adapted to measure a heart rate of the user reading the book. In a further example, the removable book cover incorporates a sensor for remotely measuring other physiological processes in the user's body, e.g. skin temperature distribution on the user's face, which are associated with changes in an emotional state of the user.

The monitoring processor 116 may be coupled to a video camera 118 for capturing video data of the user reading the book. To determine a current page read by the user in the book, a picture looked at by the user in the book or a paragraph currently read by the user, the video camera 118 may be configured to supply the captured video data to the monitoring processor 116. A subsequent content analysis of the video data may allow to determine the currently read page or the paragraph on the page, or the picture looked at. The content analysis may be performed at the monitoring processor 116 but alternatively in the device 150. The use of the video camera 118 in the user interface 110 is optional, because the part of the content currently consumed by the user may be identified in other manners. For example, the monitoring processor 116 may comprise a page counter in the form of a physical bookmark or another small gadget for identifying pages in the book.

The monitoring processor 116 may be configured to transmit to the device 150 the signal comprising the galvanic skin response measurements or other physiological data, and a reference to the corresponding part of the content looked at or listened to by the user at the time the signal was obtained. Alternatively, the device 150 is configured to receive from the monitoring processor 116 the signal and the video data that still have to be processed to identify the reference to the corresponding part of the content.

Additionally, in the user interface 130, the user may watch video and audio content, e.g. a movie, or the user may read electronic text (e.g. a newspaper or a book) shown on a display unit, e.g. a TV set or a touch screen of a PDA (Personal Digital Assistant) or a mobile phone. While the user watches the content, the signal indicating the user's heart rate, galvanic skin resistance or another physiological parameter. The signal may be obtained in various manners. For instance, the display unit may have a keyboard or a remote control unit incorporating a sensor for obtaining the physiological data.

The display unit may be configured to supply to the device 150 an identifier of the part of the content related to the corresponding physiological data in the signal. For example, the display unit may indicate a frame number in a movie, or a moment of time from the beginning of the movie. The display unit may also indicate that the physiological data relate to a specific video object or a character shown in the movie. In another example, the display unit does not explicitly provide the identifier to the device 150 but the display unit transmits the content and the signal to the device 150 synchronised in time.

The physiological data may also be obtained via one or more earphones. The earphone may be designed to measure the galvanic skin response as an extra option to the normal function of the earphone for reproducing audio to the user. For example, the surface of the earphone may include one or electrodes for sensing the galvanic skin response. The user may use such one or more earphones in the user interface 110 or 130.

Thus, the device 150 may receive from the monitoring processor 116 or from the display unit the physiological data and all information required to establish a reference to the part of the content related to the corresponding physiological data.

The device 150 may comprise a data processor 151 configured to generate, from the received physiological data, e.g. incorporated into the signal, and other information for identifying the part of the content related to the corresponding physiological data, an index indicating the identified part of the content and corresponding physiological data. Alternatively, the data processor 151 may be configured to embed the physiological data into the content at the corresponding part of the content. In a further alternative, the data processor is configured to translate the physiological data into a corresponding emotional descriptor associated with a respective emotional state of the user. Subsequently, one or more emotional descriptors may be embedded into the corresponding part of the content, or an index may be generated for indicating the identified part of the content and the corresponding emotional descriptor. The device 150 may be configured to (remotely) communicate with a data storage 160 that is adapted to store the index, or the content with the embedded physiological data or the embedded emotional descriptors. The data storage 160 may be suitable to be queried as a database.

The index and/or the content may be stored in the data storage 160 on different data carriers such as, an audio or video tape, an optical storage discs, e.g., a CD-ROM disc (Compact Disc Read Only Memory) or a DVD disc (Digital Versatile Disc), floppy and hard-drive disk, etc, in any format, e.g., MPEG (Motion Picture Experts Group), MIDI (Musical Instrument Digital Interface), Shockwave, QuickTime, WAV (Waveform Audio), etc. For example, the data storage may comprise a computer hard disk drive, a versatile flash memory card, e.g., a “Memory Stick” device, etc.

As explained with reference to FIG. 1, the presentation of the content to the user may be of two types. The user may consume the content nonlinearly in time. For example, the user may browse photos in a photo book shown on the display unit in the user interface 130. To display another photo from the photo book, the user may press a directional button on the remote control unit or a key on the keyboard at any moment. In another example, the content is presented with a predetermined progression in time. Such content may be a movie, a song or a slideshow where slides are automatically changed. In both types of the content presentation, i.e. linear and nonlinear in time, it is possible to identify the part of the content related to the corresponding physiological data using at least one of two methods: on the basis of a time of obtaining the physiological data, or by monitoring the user paying attention to a specific part of the content information. In an example of the first method, the content may be a movie. The time of obtaining the physiological data may be registered with a timer (not shown) implemented in the monitoring processor 116 or in the data processor 151. Given the registered time, it is easy to determine a frame or a video scene in the movie in response to which the user experienced a particular emotion and accordingly the corresponding physiological data was obtained.

Another example of the first method is given for the user interface 110. The time-based identification of the part of the content related to the corresponding physiological data may be performed by first activating the timer when a page is opened in the book 112 and stopping the timer when the page is going to be turned over. Thus, the timer allows to determine a total period of reading one (two) pages of the book 112. It is also assumed to be known what physiological data are received at the same period. Further, it may interpolated which paragraph of the text on the book pages relates to the corresponding physiological data. On the other hand, if the user browses through the pages, the pages couldn't be read if the determined period is less than e.g. 1 sec per page or a picture/photo, and data processor may be configured to ignore the physiological data obtained during the determined period.

In the second method, the content may be the photo book, for example. A monitoring unit, e.g. the camera 118 or the page counter attached to the book 112, allows to determine the part of the content consumed by the user at a specific moment. For example, the camera 118 is configured to capture the video data that comprise the part of the content to be identified by e.g. comparing the video data with the content. In case of the photo book, a particular one of images may be identified. When the content is the movie, a particular frame may be similarly identified.

A more accurate identification may be achieved by detecting an object on which the user is focused while looking at the photo book or the movie. The detection of the object may require that the camera 118 be used to determine a direction of a look of the user and a position of the book 112 or the display unit for displaying the content. Methods for detecting the object on the screen or the book are known as such. The object detection allows to relate the physiological data to a specific semantic portion of the content, such as the character in the movie or a singer in a duet song.

The accurate identification is also possible in the user interface 110 using the interpolation to determine the paragraph of the book page relating to the corresponding physiological data as described above. In case there is a picture on the page, the user would look first at the picture. Hence, there is also a direct coupling possible between the physiological data obtained just after the page is opened and the picture.

In one embodiment of the present invention, it is foreseen to adapt the data processor 151 to identify the part of the content related to the corresponding physiological data in such a way that an effect of aggregated user emotions is compensated. The effect may arise because the user emotions may aggregate while the user consumes the content and the physiological data may not objectively reflect the emotion related to the specific part of the content. The effect may be mitigated in an advantageous way, for example, in the user interface 130 when the user browses the photo book by delaying the synchronization between photos and the physiological data. The delay would take into account that the user may need some time to clear and calm down the emotions when one photo is shown after another one.

The data processor 151 may be a well-known central processing unit (CPU) suitably arranged to implement the present invention and enable the operation of the device as explained herein.

The invention is further explained with reference to FIG. 2 showing an embodiment of the method of analyzing the emotional state of the user when the user consumes the content.

In step 210, the physiological data are obtained when the user watches e.g. the movie, listens to a song, or reads the book. The physiological data allow to derive the emotional state of the user at the particular moment of consuming the content. For example, an extent of an excitement of the user may be deduced. Certain physiological data may also allow to reliably deduct and classify an emotional condition such as anger, worry, happiness, etc.

In an optional step 220, the physiological data are compared with a predetermined criterion for determining whether the physiological data exceed a certain level of the emotional response of the user to the consumed part of the content. For instance, the galvanic skin response may vary depending on the emotional state level of the user.

If in step 220 it is concluded from the physiological data that the emotional state level is above a threshold value, the part of content related to the physiological data is identified in step 230. The correspondence between the physiological data and the corresponding identified part of the content is determined as described above with reference to the user interface 110 or 130.

In step 240, the index is stored in the data storage 160. Alternatively, the physiological data or at least one emotional descriptor is embedded in the content with the reference to the related part of the content, and the content is stored in the data storage 160.

Optionally, if the threshold is exceeded as in step 220, the video data captured by the camera 118 directed at the user are used to derive the emotional state and the behaviour of the user, e.g. an expression of the user's face. Alternatively or additionally, an audio input device, e.g. a microphone, is activated to record the user's voice. The video data and/or the voice data may be supplied to the device 150 and further stored in the data storage 160. Thus, the experience of the user is recorded and may be presented to the user or another person any time later, for example simultaneously with the content itself in a synchronous manner.

In step 250, the content information is presented synchronously with the physiological data. The presentation may be performed in different ways, provided that a presentation of the part of the content is accompanied with a synchronous presentation of the physiological data related to that part of the content. For example, the movie is presented in a normal way on the display screen but a colour of a frame around the display screen changes in accordance with the physiological data related to the corresponding frame of the movie.

In an advantageous alternative to step 250, the part of the content is presented in a modified way depending on the corresponding related physiological data. For example, the video object of the movie is highlighted or emphasized in another way if the physiological data related to the object indicate that the user experienced certain emotions for that video object. The highlighting may comprise a usage of a colour corresponding to a specific emotion derived from the physiological data.

Alternatively, the physiological data are used to filter from the content only one or more parts of the content which meet a selected criterion. For instance, the user may like to extract from the photo book only the images evoking a certain emotion.

It is also possible to make a synopses the content of any desired length. For example, parts of the content are marked for the synopsis if the corresponding physiological data indicate the emotional level above a certain threshold. By adapting the threshold, the user or the data processor could adjust time length and the size of the synopsis.

In another embodiment, the physiological data of the user are compared with further physiological data of another user with respect to the same content. The comparison may allow the users to establish whether they like the same content or not and, optionally, a degree to which the users liked the same or different parts of the same content.

In a further embodiment, the user is enabled to use the physiological data to search in the data storage 160 for a further content with substantially the same physiological data. For example, a user-operated query for querying the data storage 160 may comprise a pattern of the physiological data distributed in a certain way over the content. In other words, the pattern may indicate that the emotional response of the user is high in the middle and especially the end of the content. Such a pattern constructed on the basis of the content may be used to find another content with the same or similar pattern.

Variations and modifications of the described embodiment are possible within the scope of the inventive concept. For example, the device 150 and/or the data storage 160 may be remotely accessible to a user device such as a television set (TV set) with a cable, satellite or other link, a videocassette- or HDD-recorder, a home cinema system, a portable CD player, a remote control device such as an iPronto remote control, a cell phone, etc. The user device may be configured to carry out the step 250 or the mentioned alternatives to the step 250.

In one embodiment, the system shown in FIG. 1 is implemented in a single device, or it comprises a service provider and a client. Alternatively, the system may comprise devices that are distributed and remotely located from each other.

The data processor 151 may execute a software program to enable the execution of the steps of the method of the present invention. The software may enable the device 150 independently of where the software is being run. To enable the device, the data processor may transmit the software program to the other (external) devices, for example. The independent method claim and the computer program product claim may be used to protect the invention when the software is manufactured or exploited for running on the consumer electronics products. The external device may be connected to the data processor using existing technologies, such as Blue-tooth, IEEE 802.11 [a-g], etc. The data processor may interact with the external device in accordance with the UPnP (Universal Plug and Play) standard.

A “computer program” is to be understood to mean any software product stored on a computer-readable medium, such as a floppy disk, downloadable via a network, such as the Internet, or marketable in any other manner.

The various program products may implement the functions of the system and method of the present invention and may be combined in several ways with the hardware or located in different devices. The invention can be implemented by means of hardware comprising several distinct elements, and by means of a suitably programmed computer. In the device claim enumerating several means, several of these means can be embodied by one and the same item of hardware.

1. A method of analysing an emotional state of a user being provided with content information in a consumer electronics interface (110, 130), the method comprising steps of:
(210) obtaining physiological data indicating the user's emotional state;
(230) identifying a part of the content information related to the physiological data; and
(240) storing the physiological data with a reference to the related part of the content information.

2. The method of claim 1, wherein the physiological data comprise a galvanic skin response measurement.

3. The method of claim 2, wherein the physiological data are obtained via a user's earphone.

4. The method of claim 1, wherein the content information is suitable for a linear in time reproduction.

5. The method of claim 1, wherein the content information is suitable for consumption by the user nonlinearly in time.

6. The method of claim 5, wherein the content information is electronic text, printed text or a plurality of images.

7. The method of claim 4, wherein the part of the content information is identified on the basis of a time of obtaining the related physiological data.

8. The method of claim 4, wherein the part of the content information related to physiological data is identified by monitoring the user being provided with content information.

9. The method of claim 1, wherein, in the step of storing, the physiological data are embedded into the content information.

10. The method of claim 1, further comprising a step (220) of determining whether the physiologic data exceed a threshold to trigger the identifying step and the storing step.

11. The method of claim 10, further comprising a step of activating, if the threshold is exceeded, a camera (118) or an audio input device to record respectively video data of the user or voice data of the user.

12. The method of claim 1, further comprising any one of steps
(250) re-providing the content information synchronously with the physiological data;
selecting at least one part of the content information related to the physiological data according to a selected criterion;
comparing the physiological data of the user with further physiological data of a second user with respect to the same content information;
using the physiological data to search in a data storage for a further content information with substantially the same physiological data.

13. A device (150) for analysing an emotional state of a user being provided with content information in a consumer electronics interface (110, 130), the device comprising a data processor (151) for
obtaining physiological data indicating the user's emotional state;
identifying a part of the content information related to the physiological data; and
enabling to store the physiological data with a reference to the related part of the content information.

14. Physiological data indicating an emotional state of a user being provided with content information in a consumer electronics interface (110, 130), the physiological data having a reference to a related part of the content information.

15. A computer program including code means adapted to implement, when executed on a computing device, the steps of the method as claimed in claim 1.
